(19) United States
(12) Patent Application Publication
(10) Pub. No.: US 2017/0018354 A1
(43) Pub. Date: Jan. 19, 2017

(54) TENSION BAR

(71) Applicant: Virginia Transformer Corporation, Roanoke, VA (US)

(72) Inventor: Subhas SARKAR, Roanoke, VA (US)

(73) Assignee: VIRGINIA TRANSFORMER CORPORATION, Roanoke, VA (US)

(21) Appl. No.: 14/801,444

(22) Filed: Jul. 16, 2015

(51) Int. Cl. H01F 41/02; H01F 3/02

(52) U.S. Cl. CPC H01F 41/02; H01F 3/02

(57) ABSTRACT

A tension bar for applying pressure more uniformly by the core bracket of a transformer may be provided. The tension bar may include a bow-shaped flat bar having at least one tightening bolt disposed therein. The at least one tightening bolt may be adjusted to apply pressure on a channel bracket clamping the yoke of a transformer. The tension bar may allow for tension to be applied uniformly along the length of the channel bracket used to clamp the yoke.

### BACKGROUND

The yoke laminations of transformer cores are generally clamped by structural members made of steel. Channel-shaped sections, or brackets, are commonly employed for this purpose. The brackets are generally secured by tie rods, which may be tightened to clamp the yoke between the channel brackets. Brackets, however, may not exert uniform pressure along the yoke. As tie rods are tightened on either side of the laminations, it can cause the middle of the channel bracket span to bow outward, away from the laminations. Yoke bolts, which pass through the lamination layers, are also commonly used. The use of yoke bolts can result in higher core losses and a risk of failure due to shorting the yoke laminations. When pressure is not applied uniformly along the laminations, it may lead to bulging, dimensional problems, and the generation of unwanted sound. A bracket capable of applying even pressure, without passing bolts through the lamination layers, is therefore be desired.

### SUMMARY

In an exemplary embodiment, transformer core bracket tension bar may be provided. The tension bar may be an elongated, bow-shaped flat bar configured to be affixed along a longitudinal axis of a channel bracket. The bar may further include at least one tightening bolt, which may be adjustably disposed through the bar. The at least one tightening bolt may be configured to apply pressure to a side of the channel bracket, opposite the yoke, when tightening.

In another exemplary embodiment, a transformer core bracket may be provided. The bracket may include two channel brackets configured to align adjacent each side of a yoke. The channel brackets may be tied together by at least one tie rod at each end of the channel brackets, such that the yoke is clamped between the brackets. The bracket may further include at least one tension bar, which may be an elongated, bow-shaped flat bar configured to be affixed along a longitudinal axis of a channel bracket. The bar may further include at least one tightening bolt, which may be adjustably disposed through the bar. The at least one tightening bolt may be configured to apply pressure to a side of the channel bracket, opposite the yoke, when tightened.

In a further exemplary embodiment, a method for applying pressure more uniformly with the core bracket may be provided. The method may include clamping a yoke between two channel brackets, affixed by tie rods at each end. The channel brackets may have at least one tension bar configured to adjust the deflection of the channel brackets. The method may further include manipulating the tension bar to adjust the deflection of the channel brackets.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a perspective view showing an exemplary embodiment of a tension bar applied to a transformer core;

FIG. 2 is a top plan view showing an exemplary embodiment of a tension bar applied to a transformer core; and

FIG. 3 is a perspective view showing an exemplary embodiment of multiple tension bars applied to a transformer core.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

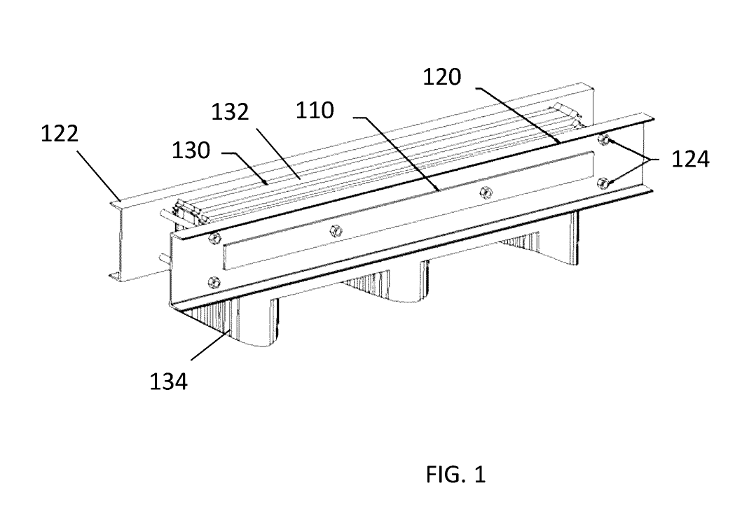

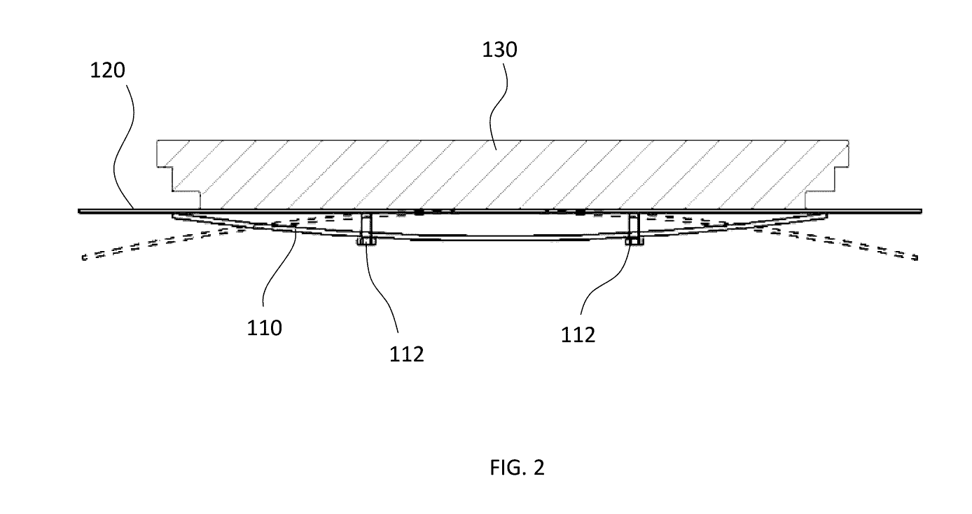

Referring to exemplary FIG. 1-2, a tension bar 110 may be applied to a channel bracket 120, 122 in order to apply pressure more uniformly to the laminations 130 of a transformer core. Channel brackets 120, 122 may be used to clamp together the stacked laminations of a transformer core, which may include the yoke laminations 132 and leg laminations 134. Applying pressure on the laminations 130 may maintain a desired space factor. In an exemplary embodiment, channel brackets 120, 122 may be placed adjacent to each side of the yoke laminations 132 and may be secured together by tie rods 124 at the ends of the channel brackets, outside of the lamination layers 130. Tie rods 124 may be adjusted to vary the tightness of the clamp. By securing channel brackets 120, 122 with tie rods 124, laminations 130 may be clamped together. As tie rods 124 are tightened, the middle of the channel bracket span may deflect outward. A tension bar 110 may be applied to channel brackets 120, 122 to prevent channel brackets 120, 122 from bulging apart between tie rods 124. A tension bar 110 may be a bow-shaped flat bar of steel, the ends of which may be affixed to a channel bracket 120, 122 at desired locations. In an exemplary embodiment, tension bar 110 may be affixed longitudinally along channel bracket 120, 122. In some exemplary embodiments, tension bar 110 may be affixed by welding each end to channel bracket 120, 122. Tension bar 110 may be affixed by a variety of fasteners as would be understood by a person having ordinary skill in the art. Alternatively, tension bar 110 may be formed integrally with channel bracket 120, 122.

Tension bar 110 may further include at least one tightening bolt 112, which may adjustably pass through tension bar 110. The at least one tightening bolt 112 may be of an appropriate length to apply pressure on a channel bracket 120, 122 when tightened through tension bar 110, as would be understood by a person having ordinary skill in the art. In some embodiments, tension bar 110 may include two tightening bolts 112. The at least one tightening bolt 112 may be positioned at a desired location along the length of tension bar 110. In some exemplary embodiments having multiple tightening bolts 112, bolts 112 may be spaced evenly along the length of tension bar 110. In an exemplary embodiment, the at least one tightening bolt 112 may be adjustably engaged with tension bar 110, such that the distance tightening bolt 112 protrudes on either side of tension bar 110 may be adjusted. In some exemplary embodiments, tightening bolt 112 may be threadably engaged with tension bar 110. The at least one bolt 112 may be of appropriate length that the ends of bolt 112 may contact channel bracket 120, 122 when tightened through tension bar 110. The at least one bolt 112 may apply pressure on channel bracket 120, 122, which may in turn prevent channel bracket 120, 122 from bulging away from the laminations 130 due to outward pressure from the laminations 130.

In an exemplary embodiment, tension bar 110 may create a deflection in channel bracket 120, 122 in the opposite direction from the deflection caused by the pressure of the yoke laminations, as shown in FIG. 2. The opposing deflections may cancel each other and the channel bracket may maintain desired flatness, which may keep the laminations 130 under pressure throughout the entire length of the yoke 132. Tension bar 110 may be designed and sized to achieve the desired deflection. Additionally, tightening bolts 112 may be manipulated to adjust the deflection, as would be understood by a person having ordinary skill in the art.

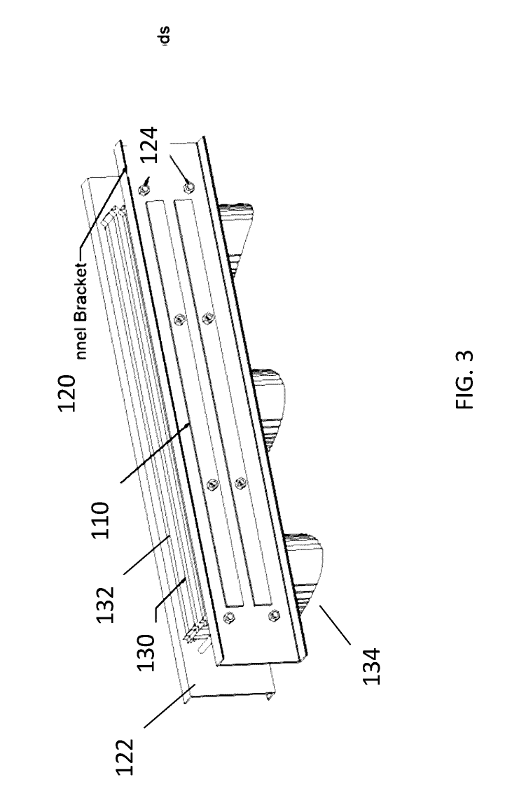

In some exemplary embodiments, as shown in exemplary FIG. 3, multiple tension bars 110 may be applied to a channel bracket 120. Different numbers of tension bars 110 or different size tension bars 110 and tightening bolts 112 may be necessary to function properly with different size transformers. In transformers having yoke laminations with a large width, there may be a correspondingly wide channel bracket for clamping the yoke. In such embodiments, additional correcting force may be required. Additional correcting force may be applied through additional tensioning bars 110.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A transformer core bracket tension bar, comprising:
an elongated, bow-shaped flat bar configured to be affixed along a longitudinal axis of a channel bracket, the bar further comprising at least one tightening bolt adjustably disposed therein, wherein the at least one tightening bolt is configured to apply pressure to a side of the channel bracket opposite the yoke when tightened.

2. The tension bar of claim 1, wherein the tension bar is comprised of steeL

3. The tension bar of claim 1, further comprising two tightening bolts.

4. The tension bar of claim 1, wherein the at least one tightening bolt is threadably engaged through the bow-shaped flat bar.

5. A transformer core bracket, comprising:
two channel brackets configured to align adjacent each side of a yoke, wherein the channel brackets are tied together by at least one tie rod at each end, such that the yoke is clamped between the channel brackets; and
at least one tension bar, the at least one tension bar comprising an elongated, bow-shaped flat bar configured to be affixed along a longitudinal axis of a channel bracket, the bar further comprising at least one tightening bolt adjustably disposed therein, wherein the at least one tightening bolt is configured to apply pressure to a side of the channel bracket opposite the yoke when tightened.

6. The bracket of claim 5, wherein the at least one tension bar is comprised of steel.

7. The bracket of claim 5, wherein the at least one tension bar comprises two tightening bolts.

8. The bracket of claim 5, wherein the at least one tightening bolt is threadably engaged through the at least one tension bar.

9. The bracket of claim 5, further comprising at least one tension bar affixed to each channel bracket.

10. The bracket of claim 5, further comprising two tension bars affixed to each channel bracket.

11. A method for applying pressure more uniformly with the core bracket, comprising:
clamping a yoke between two channel brackets affixed by tie rods at each end, the channel brackets having at least one tension bar configured to adjust the deflection of the channel brackets; and
manipulating the tension bar to adjust the deflection of the channel brackets.

12. The method of claim 11, wherein the at least one tension bar is comprised of steel.

13. The method of claim 11, wherein the two channel brackets each further comprise two tension bars.

14. The method of claim 11, wherein the at least one tension bar comprises an elongated, bow-shaped flat bar configured to be affixed along a longitudinal axis of a channel bracket, the bar further comprising at least one tightening bolt adjustably disposed therein, wherein the at least one tightening bolt is configured to a side of the channel bracket opposite the yoke when tightened.

15. The method of claim 14, wherein manipulating the tension bar to adjust the deflection of the channel brackets further comprises adjusting the at least one tightening bolt of the at least one tension bar.

16. The method of claim 14, wherein the at least one tightening bolt is threadably engaged through the at least one tension bar.
